(19) United States
(12) Patent Application Publication
(10) Pub. No.: US 2023/0289748 A1
(43) Pub. Date: Sep. 14, 2023

(54) CONSUMER WASTE AND RECYCLING GUIDANCE SYSTEM

(71) Applicant: Scrapp LLC, Burlington, MA (US)

(72) Inventors: Michael Vincent Pasciuto, Burlington, MA (US); Thomas R. Evangelista, Bourne, MA (US); John J. Scarfo, Burlington, MA (US); Evan Gwynne Davies, Andover (GB); Daniel Marek, Devon (GB)

(21) Appl. No.: 18/177,343

(22) Filed: Mar. 2, 2023

Related U.S. Application Data
(60) Provisional application No. 63/318,600, filed on Mar. 10, 2022.

(51) Int. Cl. G06Q 10/30; G06K 7/14; H04W 4/02

(52) U.S. Cl. CPC G06Q 10/30; G06K 7/1417; H04W 4/025

(57) ABSTRACT

Techniques for generating component-level disposal guidance for a product are described. A computing system may receive a request for disposal information, where the request includes an identifier (e.g., barcode or QR code) for a product, and location information. The computing system determine product information (e.g., one or more components, one or more packaging symbols, and/or one or more contents of the product) associated with the reference identifier. The computing system may also determine a disposal scheme associated with the location information, and disposal bin information associated with the disposal scheme. The disposal bin information may representing a type(s) of disposal bin(s), where each type is represented as being usable to dispose of one or more material types. The computing system may, using the disposal bin information and the product information, determine disposal guidance at a disposal bin/product component level, and send the disposal guidance to the computing device for output.

### RELATED APPLICATION

The present application claims benefit under 35 U.S.C. § 119(e) to U.S. Provisional Application No. 63/318,600, filed on Mar. 10, 2022, the contents of which are incorporated by reference herein in their entirety.

### BACKGROUND

Household waste is deposited at landfills at an astounding rate. Daily, humans place recyclable materials in the garbage, resulting in said materials not being beneficially deconstructed and reused. Additionally, consumers placing non-recyclable items in recycling bins causes materials to not be beneficially deconstructed.

At least part of the problem in improper recycling is the difficulty of determining which items are recyclable. Traditional methods of identifying whether an item is recyclable or not are heavily reliant on the individual correctly recycling the item based on previous knowledge from static leaflets, town bulletins, and web lookups.

### SUMMARY

Disclosed herein are techniques for providing component-, material-, sustainability-, and location-specific disposal guidance to maximize disposal (e.g., recycling) potential for a product. Some embodiments involve identifying the recyclability of a product and its packaging using the product's barcode and based on the user's location, the product's packaging material, and the product's components.

A first aspect of the present disclosure relates to a computing system for generating component-level disposal guidance for a product. The computing system may be configured to receive, from a computing device, a first request for disposal information for a first product, where the first request comprises a reference identifier of the first product, and location information. The computing system may also be configured to determine, in a first storage, product information associated with the reference identifier of the first product, where the product information includes one or more of: one or more components of the first product, one or more packaging symbols of the first product, and one or more contents of the first product. The computing system may further be configured to determine, in a second storage, a disposal scheme associated with the location information. The computing system may also be configured to determine, in the second storage, disposal bin information associated with the disposal scheme, the disposal bin information representing one or more types of disposal bins, where each of the one or more types of disposal bins is represented as being usable to dispose of one or more corresponding types of material. The computing system may be configured to, using the disposal bin information and the product information, determine disposal data for the first product, where the disposal data provides disposal guidance at a disposal bin/product component level. The computing system may be configured to send the disposal data to the computing device for output.

In some embodiments of the first aspect, the reference identifier may be a barcode or a quick response (QR) code.

In some embodiments of the first aspect, the first request may comprise an image of the reference identifier, and the computing system may be configured to process the image to identify the reference identifier.

In some embodiments of the first aspect, the location information may comprise latitude and longitude coordinates of the computing device.

In some embodiments of the first aspect, the location information may comprise a geographic area identifier.

In some embodiments of the first aspect, the first request may comprise information for a disposal program to be used to dispose of the first product.

In some embodiments of the first aspect, the one or more components may comprise one or more of a 6 pack ring, an aerosol can, an applicator, a backing, a bag, a band, a binding, a blister pack, a book backing, a bottle, a box, a bubble wrap, a bucket, a can, a canister, a cap, a card, a carrier, a case, a clamshell, a coffee pod, a cork, a cup, a detachable nozzle, an egg carton, an envelope, a film, a flat-top carton, a foil, a gable-top carton, glitter, a handle, a hanger, a jar, a jug, a label, a lid, a net, a packaging insert, packaging peanuts, a packet, a pad/layer sheet, paper, a peel-off lid, a plate/base, a pot, a pouch, a pump dispenser, a roll, a sleeve, a stick, a straw, a string, a tag, a tank, tape, a tea bag, a tie, a tray/punnet, a trigger spray, a tub, a tube, a utensil, a window, and a wrap.

In some embodiments of the first aspect, the one or more packaging symbols may comprise one or more of B-Corps, 1% for the Planet, Friend of the Sea, Friend of the Earth, Fairtrade, Ecocert, PETA Bunny, Leaping Bunny, RSPO, FSC, Dolphin Safe, BPI, Global Organic Textile Standard, Global Recycle Standard, The Green Dot, Green Globe Certification, MSC, Non-GMO, Rainforest Alliance, World Land Trust, TerraCycle, Loop, Fair For Life, Certified Humane, Refill, Safer Choice, and Energy Star, FSC: Mix From Responsible Sources, Elopak, Tetra Pak, Magnetic Tin, Recyclable Aluminium, Aluminium 41, Metal Recycles Forever, Steel 40, FSC: Made From Recycled Material, FSC: Made From Well-Managed Forests, PEFC, Corrugated Recycles, RESY, Cardboard 20, Mixed Paper 21, Paper 22, Paperboard 23, Paper and Plastic 81, 100% Recycled Paperboard, PET, R-PET, HDPE, PVC, LDPE, PP, PS, ABS, Polyamide, FEVE, Clear Glass 70, Green Glass 71, Brown Glass 72, Seedling, Home Composting, OK Compost, OK Biodegradable, Wood 50, Cork 51, Cotton 60, WEEE, Gluten-Free, and Mobius Loop.

In some embodiments of the first aspect, the disposal scheme may be selected from the group consisting of a public disposal scheme and a private disposal scheme.

In some embodiments of the first aspect, the computing system may be configured to receive, from a computing device, a second request for disposal information for a second product, where the second request comprises a reference identifier of the second product; determine the reference identifier, of the second product, is missing from the first storage; send, to the computing device, first data requesting information related to the second product; receive, from the computing device, second data representing one or more of one or more components of the second product, one or more packaging symbols of the second product, and one or more contents of the product; and store, in the first storage, an association between the reference identifier, of the second product, and the second data.

In some embodiments of the first aspect, the first request may indicate a preconfigured disposal scheme, and the computing system may be configured to determine, in the second storage, the disposal scheme to be the preconfigured disposal scheme.

In some embodiments of the first aspect, the computing system may be configured to determine an alternative disposal option associated with the location information and, using the alternative disposal option and the product information, determine the disposal data to further provide disposal guidance at an alternative disposal option/product component level.

In some embodiments of the first aspect, the product information may further include a product category.

In some embodiments of the first aspect, the product information may further include a product type.

A second aspect of the present disclosure relates to a computer-implemented method for generating component-level disposal guidance for a product. The computer-implemented method may comprise receiving, from a computing device, a first request for disposal information for a first product, where the first request comprises a reference identifier of the first product, and location information. The computer-implemented method may also comprise determining, in a first storage, product information associated with the reference identifier of the first product, where the product information includes one or more of: one or more components of the first product, one or more packaging symbols of the first product, and one or more contents of the first product. The computer-implemented method may further comprise determining, in a second storage, a disposal scheme associated with the location information. The computer-implemented method may also comprise determining, in the second storage, disposal bin information associated with the disposal scheme, the disposal bin information representing one or more types of disposal bins, where each of the one or more types of disposal bins is represented as being usable to dispose of one or more corresponding types of material. The computer-implemented method may comprise determining, using the disposal bin information and the product information, disposal data for the first product, where the disposal data provides disposal guidance at a disposal bin/product component level. The computer-implemented method may comprise sending the disposal data to the computing device for output.

In some embodiments of the second aspect, the reference identifier may be a barcode or a quick response (QR) code.

In some embodiments of the second aspect, the first request may comprise an image of the reference identifier, and the computer-implemented method may comprise processing the image to identify the reference identifier.

In some embodiments of the second aspect, the location information may comprise latitude and longitude coordinates of the computing device.

In some embodiments of the second aspect, the location information may comprise a geographic area identifier.

In some embodiments of the second aspect, the first request may comprise information for a disposal program to be used to dispose of the first product.

In some embodiments of the second aspect, the one or more components may comprise one or more of a 6 pack ring, an aerosol can, an applicator, a backing, a bag, a band, a binding, a blister pack, a book backing, a bottle, a box, a bubble wrap, a bucket, a can, a canister, a cap, a card, a carrier, a case, a clamshell, a coffee pod, a cork, a cup, a detachable nozzle, an egg carton, an envelope, a film, a flat-top carton, a foil, a gable-top carton, glitter, a handle, a hanger, a jar, a jug, a label, a lid, a net, a packaging insert, packaging peanuts, a packet, a pad/layer sheet, paper, a peel-off lid, a plate/base, a pot, a pouch, a pump dispenser, a roll, a sleeve, a stick, a straw, a string, a tag, a tank, tape, a tea bag, a tie, a tray/punnet, a trigger spray, a tub, a tube, a utensil, a window, and a wrap.

In some embodiments of the second aspect, the one or more packaging symbols may comprise one or more of B-Corps, 1% for the Planet, Friend of the Sea, Friend of the Earth, Fairtrade, Ecocert, PETA Bunny, Leaping Bunny, RSPO, FSC, Dolphin Safe, BPI, Global Organic Textile Standard, Global Recycle Standard, The Green Dot, Green Globe Certification, MSC, Non-GMO, Rainforest Alliance, World Land Trust, TerraCycle, Loop, Fair For Life, Certified Humane, Refill, Safer Choice, and Energy Star, FSC: Mix From Responsible Sources, Elopak, Tetra Pak, Magnetic Tin, Recyclable Aluminium, Aluminium 41, Metal Recycles Forever, Steel 40, FSC: Made From Recycled Material, FSC: Made From Well-Managed Forests, PEFC, Corrugated Recycles, RESY, Cardboard 20, Mixed Paper 21, Paper 22, Paperboard 23, Paper and Plastic 81, 100% Recycled Paperboard, PET, R-PET, HDPE, PVC, LDPE, PP, PS, ABS, Polyamide, FEVE, Clear Glass 70, Green Glass 71, Brown Glass 72, Seedling, Home Composting, OK Compost, OK Biodegradable, Wood 50, Cork 51, Cotton 60, WEEE, Gluten-Free, and Mobius Loop.

In some embodiments of the second aspect, the disposal scheme may be selected from the group consisting of a public disposal scheme and a private disposal scheme.

In some embodiments of the second aspect, the computer-implemented method may comprise receiving, from a computing device, a second request for disposal information for a second product, where the second request comprises a reference identifier of the second product; determining the reference identifier, of the second product, is missing from the first storage; sending, to the computing device, first data requesting information related to the second product; receiving, from the computing device, second data representing one or more of one or more components of the second product, one or more packaging symbols of the second product, and one or more contents of the product; and storing, in the first storage, an association between the reference identifier, of the second product, and the second data.

In some embodiments of the second aspect, the first request may indicate a preconfigured disposal scheme, and the computer-implemented method may comprise determining, in the second storage, the disposal scheme to be the preconfigured disposal scheme.

In some embodiments of the second aspect, the computer-implemented method may comprise determining an alternative disposal option associated with the location information and, using the alternative disposal option and the product information, determining the disposal data to further provide disposal guidance at an alternative disposal option/product component level.

In some embodiments of the second aspect, the product information may further include a product category.

In some embodiments of the second aspect, the product information may further include a product type.

### BRIEF DESCRIPTION OF DRAWINGS

For a more complete understanding of the present disclosure, reference is now made to the following description taken in conjunction with the accompanying drawings.

FIG. 1 is a conceptual diagram illustrating a computing device and a computing system for performing component-, material-, sustainability-, and location-specific disposal guidance, according to embodiments of the present disclosure.

FIG. 2 is a conceptual diagram illustrating data an application may aggregate in response to receiving a user input requesting disposal guidance for a product, according to embodiments of the present disclosure.

FIG. 3 is a conceptual diagram illustrating data that may be stored in a product storage, according to embodiments of the present disclosure.

FIG. 4 is a conceptual diagram illustrating data that may be stored in a location storage, according to embodiments of the present disclosure.

FIG. 5 is a signal flow diagram illustrating processing that may be performed when disposal information is requested for a product not known to the computing system, according to embodiments of the present disclosure.

FIG. 6 is a block diagram conceptually illustrating example components of a computing device, according to embodiments of the present disclosure.

FIG. 7 is a block diagram conceptually illustrating example components of a computing system, according to embodiments of the present disclosure.

### DETAILED DESCRIPTION

The present disclosure provides computing devices and systems configured to provide detailed component-, material-, sustainability-, and location-specific disposal guidance to maximize disposal (e.g., recycling) potential for a product. The present disclosure also provides computer-implemented methods for providing detailed component-, material-, sustainability-, and location-specific disposal guidance. Some embodiments involve identifying the recyclability of a product and its packaging using the product's barcode and based on the user's location, the product's packaging material, and the product's components.

A computing system may receive, from a computing device, a request for disposal (e.g., recycling) information for a product. The request may include a reference identifier of the product, and location information. In some embodiments, the reference identifier may be a barcode of the product, or a quick response (QR) code of the product. In some embodiments, the location information may include latitude and longitude coordinates of the computing device, and/or a geographic area identifier (e.g., city name, zip code, etc.). In some embodiments, the request may include an image of the reference identifier, and the computing system may process the image to identify the reference identifier therein. In some embodiments, the request may include information for a disposal (e.g., recycling) program to be used to dispose of the product.

The computing system may determine, in a first storage, product information associated with the reference identifier of the product. The product information may include one or more components of the product, one or more packaging symbols of the product, one or more contents of the product, a category of the product (e.g., food), and/or a product type of the product (e.g., frozen/refrigerated). Example components of the product include, but are not limited to, a 6 pack ring, an aerosol can, an applicator, a backing, a bag, a band, a binding, a blister pack, a book backing, a bottle, a box, a bubble wrap, a bucket, a can, a canister, a cap, a card, a carrier, a case, a clamshell, a coffee pod, a cork, a cup, a detachable nozzle, an egg carton, an envelope, a film, a flat-top carton, a foil, a gable-top carton, glitter, a handle, a hanger, ajar, a jug, a label, a lid, a net, a packaging insert, packaging peanuts, a packet, a pad/layer sheet, paper, a peel-off lid, a plate/base, a pot, a pouch, a pump dispenser, a roll, a sleeve, a stick, a straw, a string, a tag, a tank, tape, a tea bag, a tie, a tray/punnet, a trigger spray, a tub, a tube, a utensil, a window, and a wrap. Example packaging symbols of the product include, but are not limited to, B-Corps, 1% for the Planet, Friend of the Sea, Friend of the Earth, Fairtrade, Ecocert, PETA Bunny, Leaping Bunny, RSPO, FSC, Dolphin Safe, BPI, Global Organic Textile Standard, Global Recycle Standard, The Green Dot, Green Globe Certification, MSC, Non-GMO, Rainforest Alliance, World Land Trust, TerraCycle, Loop, Fair For Life, Certified Humane, Refill, Safer Choice, and Energy Star, FSC: Mix From Responsible Sources, Elopak, Tetra Pak, Magnetic Tin, Recyclable Aluminium, Aluminium 41, Metal Recycles Forever, Steel 40, FSC: Made From Recycled Material, FSC: Made From Well-Managed Forests, PEFC, Corrugated Recycles, RESY, Cardboard 20, Mixed Paper 21, Paper 22, Paperboard 23, Paper and Plastic 81, 100% Recycled Paperboard, PET, R-PET, HDPE, PVC, LDPE, PP, PS, ABS, Polyamide, FEVE, Clear Glass 70, Green Glass 71, Brown Glass 72, Seedling, Home Composting, OK Compost, OK Biodegradable, Wood 50, Cork 51, Cotton 60, WEEE, Gluten-Free, and Mobius Loop.

The computing system may determine, in a second storage, a disposal scheme associated with the location information. For example, the disposal scheme may be a public disposal scheme (e.g., sponsored by a city or township). For further example, the disposal scheme may be a private disposal scheme (e.g., provided by a non-governmental business). In some embodiments, the request for disposal information, as received from the computing device, may indicate a preconfigured disposal scheme. In such embodiments, the computing system may determine, in the second storage, the disposal scheme to be the preconfigured disposal scheme.

The computing system may determine disposal bin information associated with the disposal scheme. The disposal bin information may represent one or more types of disposal bins (e.g., recycling bin, compost bin, waste bin, etc.), where each of the one or more disposal bin types is represented as being usable to dispose of one or more corresponding types of material.

The computing system may, using the disposal bin information and the product information, determine disposal guidance for the product at a disposal bin/product component level. The computing system may send the disposal guidance to the computing device for output (e.g., display).

In some embodiments, the computing system may receive, from a computing device, a request for disposal information for a product, where the request includes at least a reference identifier of the product. The computing system may determine the reference identifier, of the product, is missing from the first storage. As a result, the computing system may send, to the computing device, a request for information related to the product. Thereafter, the computing system may receive, from the computing device, data representing one or more components of the product, one or more packaging symbols of the product, one or more contents of the product, a category of the product (e.g., food), and/or a product type of the product (e.g., frozen/refrigerated), as input by a user of the computing device. The computing system may thereafter store, in the first storage, an association between the reference identifier, of the product, and the foregoing data.

A computing system according to the present disclosure may be configured to incorporate user permissions and may only perform activities disclosed herein if approved by a user. As such, the computing systems, devices, components, and techniques described herein would be typically configured to restrict processing where appropriate and only process user data in a manner that ensures compliance with all appropriate laws, regulations, standards, and the like. The computing system and techniques can be implemented on a geographic basis to ensure compliance with laws in various jurisdictions and entities in which the components of the computing system and/or user are located.

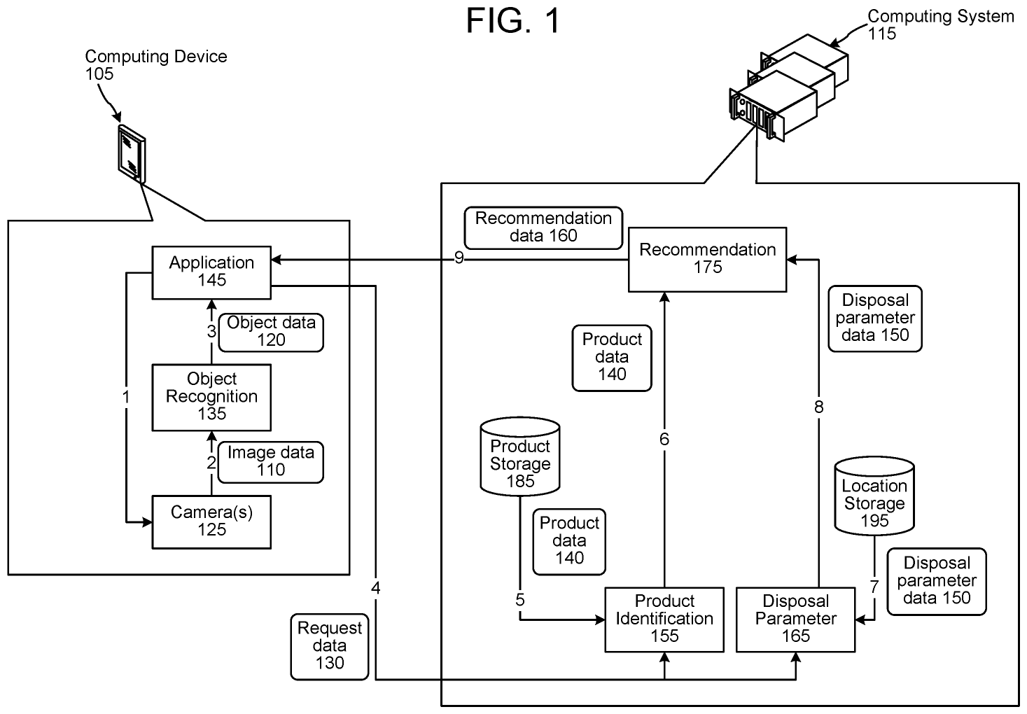

Referring to FIG. 1, a computing device 105 and a computing system 115 for performing component-, material-, sustainability-, and location-specific disposal guidance are described. The computing device 105 may include a camera(s) 125, an object recognition component 135, and an application 145. The computing system 115 may include a product identification component 155, a disposal parameter component 165, a recommendation component 175, a product storage 185, and a location storage 195. In some embodiments, the computing system 115 may be configured as a cloud computing system.

The computing device 105 and the computing system 115 may exchange data via one or more networks. The network(s) may include the Internet and/or any other wide- or local-area network, and may include wired, wireless, and/or cellular network hardware.

A user of the computing device 105 may interact with the computing device 105 to execute the application 145. The application 145 is a software package configured to perform the processing described herein. In some embodiments, the computing device 105 may be a smart phone or tablet, and the application 145 may installed on and executed by the computing device 105.

While the application 145 is being executed by the computing device 105, the user may provide a user input (e.g., spoken user input, typed user input, or some other user input performed using a graphical user interface (GUI) of the computing device 105) requesting disposal information for a product. As used herein, a product refers to an object that includes one or more disposable (e.g., recyclable, compostable, etc.) components, and which is associated with a unique barcode, quick response (QR) code, radio frequency identification (RFID) tag, or some other unique identifier.

In response to the user input, the application 145 may cause (step 1) the computing device 105 to activate the camera(s) 125 to enable the user to use the camera(s) 125 to capture an image of the product, and more particularly the unique identifier (e.g., barcode or QR code) of the product. Upon capture of the image, image data 110 corresponding to the image may be generated. The image data 110 may be sent (step 2) to the object recognition component 135.

Object recognition component 135 may process the image data 110 to identify a portion thereof corresponding to the unique identifier (e.g., barcode or QR code) of the product. The object recognition component 135 may implement a machine learning (ML) model trained to process image data to identify a barcode, QR code, or other product reference identifier represented therein. In some embodiments, the object recognition component 135 may implement a neural network model. In some embodiments, the object recognition component 135 may implement a deep neural network model. In some embodiments, the ML model may be trained using examples of image data annotated to indicate barcodes, QR code, and/or other product reference identifiers represented therein. The ML model may be trained using one or more training techniques. Example training techniques include, but are not limited to backpropagation, statistical learning, supervised learning, semi-supervised learning, and stochastic learning.

The object recognition component 135 may generate object data 120 representing and/or including the product reference identifier represented in the image data 110. The object data 120 may be sent (step 3) to the application 145.

As described above, in some instances the product may include an RFID tag. Radio frequency identification (RFID) is a form of wireless communication that incorporates the use of electromagnetic or electrostatic coupling, in the radio frequency portion of the electromagnetic spectrum, to uniquely identify an object. In situations where the user provides an input to identify the product based on an RFID tag, the application 145 may cause the computing device 105 to use an RFID detector (of or associated with the computing device 105) to detect an RFID signal output by the RFID tag of the product. Upon detecting the RFID signal, the computing device 105 may generate the object data 120 to represent the RFID identifier of the detected RFID signal, and send the object data 120 to the application 145.

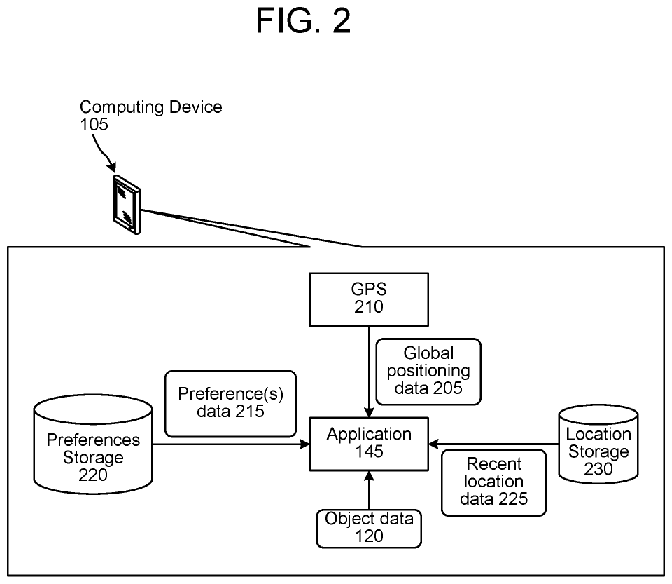

In addition to receiving the object data 120 in response to receiving the user input requesting disposal guidance for the product, the application 145 may aggregate other data usable by the computing system 115 to generate the requested disposal guidance. As illustrated in FIG. 2, the application 145 may receive global positioning data 205 from a global positioning system (GPS) 210 implemented by the computing device 105. The global positioning data 205 may include latitude and longitude coordinates corresponding to a present global position of the computing device 105.

The application 145 may also request a preferences storage 220 (implemented by the computing device 105) to obtain preference(s) data 215. The preferences storage may store, for example, information representing one or more disposal locations (e.g., “home,” “work,” “school,” etc.) frequently used by the user. A frequently-used disposal location may be represented as a zip code, town/city/village, street address, or some other location identifier in the preferences storage 220. The preferences storage may also store an association between a given frequently-used disposal location and a disposal scheme identifier corresponding to a particular disposal scheme. In some instances, a disposal scheme may be a “public” disposal scheme offered by a particular village, town, city, or the like. In some instances, a disposal scheme may be a “private” disposal scheme provided by a non-governmental business entity. Accordingly, the preference(s) data 215 may include information representing one or more disposal locations, and potentially one or more corresponding disposal scheme identifiers.

The application 145 may additionally request a location storage 230 (implemented by the computing device 105) to obtain recent location data 225. When the user requests disposal guidance, the computing device 105 may store, in the location storage 230, data representing a frequently-used disposal location of the user to be used in generating the guidance, and may also store a disposal scheme identifier associated with the frequently-used disposal location in the preferences storage 220. In some embodiments, the user may select the frequently-used disposal location (and optionally corresponding disposal scheme) to be used in generating the guidance. As such, the recent location data 225 may correspond to a most-recent of the user's frequently-used disposal locations that the user used when requesting disposal guidance using the application 145. The recent location data 225 may additionally include the disposal scheme identifier associated with the frequently-used disposal location.

Referring again to FIG. 1, the application 145 may generate request data 130 corresponding to a request for disposal guidance for the product. The request data 130 may include the object data 120, the global positioning data 205 (and/or a geographic area identifier corresponding to the global positioning data 205, such as a zip code, town/city/village name, or the like), the preference(s) data 215, the recent location data 225, and a device identifier of the computing device 105 and/or user identifier (e.g., username) of the user. In some embodiments, the computing system 115 may be configured with functionality that uses the device identifier and/or user identifier to maintain a record of the user's recycling impact. At a minimum, the request data 130 may include the object data 120 (including the identifier of the product). In some embodiments, the request data 130 may include the object data 120 and the global positioning data 205. The computing device 105 may send (step 4) the request data to the computing system 115.

In some embodiments, the computing system 115 may implement an object recognition component in addition to or instead of the computing device 105 implementing the object recognition component 135. In such embodiments, the request data 130 may include the image data 110, and the computing system-implemented objection recognition component may process the image data 110 to generating the object data 120.

In some embodiments, rather than using the camera(s) 125 or an RFID detector to determine the product reference identifier, the user may manually input (e.g., via speech or GUI interactions) information pertaining to the product. For example, such product information may include the numbers below the product's barcode, a brand/tradename associated with the product, a name of the product, one or more components of the product, one or more packaging symbols of the product, one or more contents of the product, a category of the product (e.g., food), and/or a product type of the product (e.g., frozen/refrigerated). In some embodiments, the user may provide this product information using one or more dropdown lists presented by the application 145 on a display of the computing device 105.

Within the computing system 115, the request data 130 may be sent to the product identification component 155. The product identification component 155 may communicate with the product storage 185.

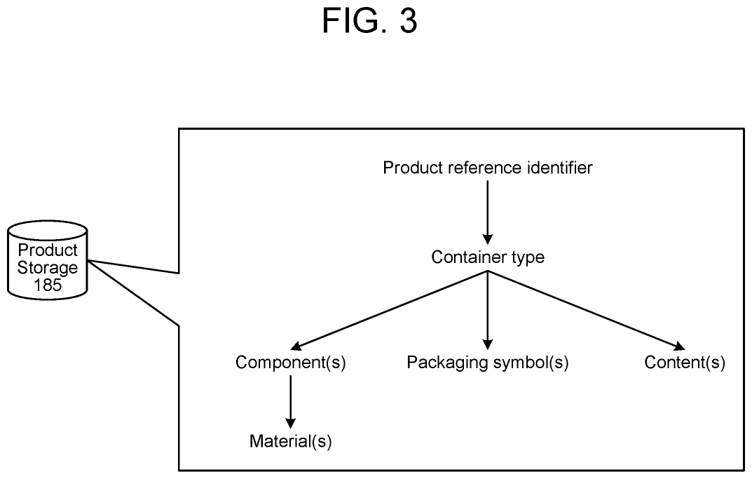

As illustrated in FIG. 3, the product storage 185 may store various data and associations. The product storage 185 may store one or more product reference identifiers (e.g., one or more barcodes, one or more QR codes, and/or one or more RFID identifiers).

Within the product storage 185, each product reference identifier may be associated with a container type. Example container types include, but are not limited to, an applicator (e.g., when the product is a deodorant or antiperspirant), a plastic bag, a blister pack, a plastic bottle, a plastic bucket, a plastic case (e.g., a compact disc (CD) case), a clamshell or punnet (e.g., for fruit packaging), a plastic egg carton, a plastic jar, a plastic jug, a juice pouch, a plastic net, a plastic pot, a pouch, a pump bottle, a spray bottle, a plastic tray, a plastic tub, a plastic tube, a utensil, a wrapper, a paper backing, a paper bag having no window, a box, a paper canister, a carrier box, a frozen food box, a sandwich bag, a paper bag having a window, a card sleeve, a paper egg carton, a paper pot, a hardback book, a softcover media, a paper tag, a flat-top carton, a gable-top carton, a juice box, a packet, a can, a metal bottle, a tin, an aerosol can, a metal tray, a metal tube, a tank, a metal bucket, a glass bottle, a glass jar, and a glass spray bottle.

Within the product storage 185, a container type may be associated with one or more components. Example container components include, but are not limited to a 6 pack ring, an aerosol can, an applicator, a backing, a bag, a band, a binding, a blister pack, a book backing, a bottle, a box, a bubble wrap, a bucket, a can, a canister, a cap, a card, a carrier, a case, a clamshell, a coffee pod, a cork, a cup, a detachable nozzle, an egg carton, an envelope, a film, a flat-top carton, a foil, a gable-top carton, glitter, a handle, a hanger, a jar, a jug, a label, a lid, a net, a packaging insert, packaging peanuts, a packet, a pad/layer sheet, paper, a peel-off lid, a plate/base, a pot, a pouch, a pump dispenser, a roll, a sleeve, a stick, a straw, a string, a tag, a tank, tape, a tea bag, a tie, a tray/punnet, a trigger spray, a tub, a tube, a utensil, a window, and a wrap.

Within the product storage 185, a container component may be associated with one or more materials. Example container materials include, but are not limited to, hard plastic (e.g., mixed plastic, polyethylene terephthalate (PET) plastic, high density polyethylene (HDPE) plastic, polyvinyl chloride (PVC) plastic, low density polyethylene (LDPE) plastic, polypropylene (PP) plastic, polystyrene (PS) plastic, and styrofoam), soft plastic (e.g., mixed plastic, PET soft plastic, HDPE soft plastic, PVC soft plastic, LDPE soft plastic, PP soft plastic, and PS soft plastic), paper/cardboard (e.g., paper, coated paper, card, and corrugated cardboard), glass (e.g., clear glass, brown glass, and green glass), metal (e.g., aluminum, foil, and steel), mixed material (e.g., composite, mixed material, ceramic, textile, rubber, and wax), compostable/organic (e.g., home compostable, industrial compostable, biodegradable, cork, wood, and bamboo), and trash.

Within the product storage 185, a container type may also be associated with one or more packaging symbols. Example packaging symbols include, but are not limited to, B-Corps, 1% for the Planet, Friend of the Sea, Friend of the Earth, Fairtrade, Ecocert, PETA Bunny, Leaping Bunny, RSPO, FSC, Dolphin Safe, BPI, Global Organic Textile Standard, Global Recycle Standard, The Green Dot, Green Globe Certification, MSC, Non-GMO, Rainforest Alliance, World Land Trust, TerraCycle, Loop, Fair For Life, Certified Humane, Refill, Safer Choice, and Energy Star, FSC: Mix From Responsible Sources, Elopak, Tetra Pak, Magnetic Tin, Recyclable Aluminium, Aluminium 41, Metal Recycles Forever, Steel 40, FSC: Made From Recycled Material, FSC: Made From Well-Managed Forests, PEFC, Corrugated Recycles, RESY, Cardboard 20, Mixed Paper 21, Paper 22, Paperboard 23, Paper and Plastic 81, 100% Recycled Paperboard, PET, R-PET, HDPE, PVC, LDPE, PP, PS, ABS, Polyamide, FEVE, Clear Glass 70, Green Glass 71, Brown Glass 72, Seedling, Home Composting, OK Compost, OK Biodegradable, Wood 50, Cork 51, Cotton 60, WEEE, Gluten-Free, and Mobius Loop.

Within the product storage 185, a container type may additionally be associated with one or more contents. Example contents include, but are not limited to, hazardous content, flammable liquid, environmentally harmful content, harmful or irritating content, corrosive content, content not suitable for children, Federal Communication Commission content, Conformité Europeenne content, period after opening (PAO) content, and food safe content.

Within the product storage 185, a content may be associated with one or more product categories. Example product categories include, but are not limited to, food, beverage, and hazardous.

Within the product storage 185, a content may be associated with one or more product types. Example product types include, but are not limited to, facial care, skin care, hair care, fragrances, make-up, accessories, household cleaners, automotive cleaners, industrial cleaners, soap and sanitizer, miscellaneous cleaners, scrap metal, small appliances, large appliances, tools, construction and demolition, miscellaneous industrial, alcoholic, carbonated, juice, milk, tea and coffee, drink mixes, water, frozen/refrigerated, batteries, computers and devices, wires and circuits, power tools, lighting equipment, gaming systems, television and sound, electronic toys, miscellaneous electronics, meat and dairy, produce, pantry/cupboard, takeaway, vitamins and supplements, automotive, household hazardous, pesticides, biohazard, batteries, radioactive, explosives and ammunition, miscellaneous hazardous, medical device, medicine, miscellaneous healthcare, pool and spa, furniture, lawn and garden, dishware, kitchenware, miscellaneous household, catalogs, books, magazines, video games and discs, miscellaneous media, body care, dental care, miscellaneous hygiene, pet toys, miscellaneous pet supplies, pet food, clothing and apparel, linens, footwear, stuffed animals, miscellaneous textiles, board games and puzzles, arts and crafts, figures & dolls, gaming systems, and miscellaneous toys.

Referring again to FIG. 1, the product identification component 155 may query (step 5) the product storage 185 for product data 140 associated with the product reference identifier in the request data. The product data 140 may include one or more of a container type associated with the product reference identifier, a component(s) associated with the container type, a material(s) associated with the component(s), a packaging symbol(s) associated with the container type, content(s) associated with the container type, one or more product categories associated with the content(s), and/or a product type(s) associated with the one or more product categories. The product identification component 155 may send (step 6) the product data 140 to the recommendation component 175.

The request data 130 may also be sent to the disposal parameter component 165. The disposal parameter component 165 may communicate with the location storage 195.

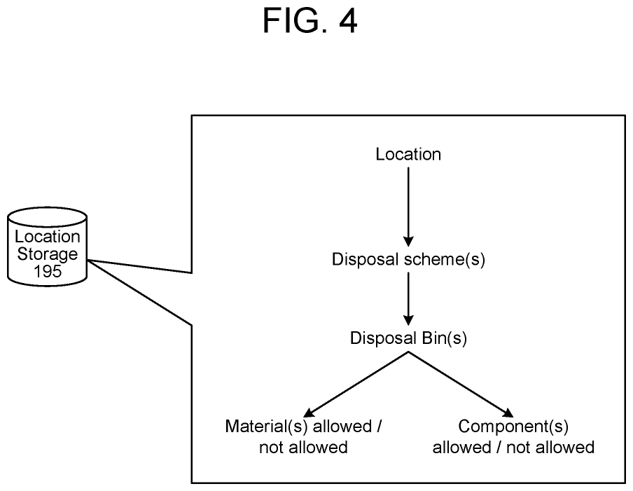

As illustrated in FIG. 4, the location storage 195 may store various data and associations. The location storage 195 may store data representing one or more locations, where each location corresponds to a physical space on a map, such as a village, town, city, zip code, etc.

Within the location storage 195, each location may be associated with one or more disposal schemes, where each disposal scheme corresponds to a different disposal scheme offered in the associated location. A disposal scheme may be a “public” disposal scheme offered by a particular village, town, city, or the like. Alternatively, a disposal scheme may be a “private” disposal scheme provided by a non-governmental business entity.

Within the location storage 195, each disposal scheme may be associated with one or more disposal bins, where each disposal bin corresponds to a different recycling bin, waste bin, or compost bin. In some embodiments, a disposal bin may be defined by the associated disposal scheme. In some embodiments, a disposal bin may be generally defined to apply to two or more disposal schemes stored in the location storage 195.

Within the location storage 195, a disposal bin may be associated with data representing one or more materials that are allowed to be disposed of using the disposal bin and/or one or more materials that are not allowed to be disposed of using the disposal bin. Example material types include, but are not limited to, hard plastic (e.g., mixed plastic, PET plastic, HDPE plastic, PVC plastic, LDPE plastic, PP plastic, PS plastic, and styrofoam), soft plastic (e.g., mixed plastic, PET soft plastic, HDPE soft plastic, PVC soft plastic, LDPE soft plastic, PP soft plastic, and PS soft plastic), paper/cardboard (e.g., paper, coated paper, card, and corrugated cardboard), glass (e.g., clear glass, brown glass, and green glass), metal (e.g., aluminum, foil, and steel), mixed material (e.g., composite, mixed material, ceramic, textile, rubber, and wax), compostable/organic (e.g., home compostable, industrial compostable, biodegradable, cork, wood, and bamboo), and trash.

Within the location storage 195, a disposal bin may also or alternatively be associated with data representing one or more components that are allowed to be disposed of using the disposal bin and/or one or more components that are not allowed to be disposed of using the disposal bin. Example components include, but are not limited to a 6 pack ring, an aerosol can, an applicator, a backing, a bag, a band, a binding, a blister pack, a book backing, a bottle, a box, a bubble wrap, a bucket, a can, a canister, a cap, a card, a carrier, a case, a clamshell, a coffee pod, a cork, a cup, a detachable nozzle, an egg carton, an envelope, a film, a flat-top carton, a foil, a gable-top carton, glitter, a handle, a hanger, a jar, a jug, a label, a lid, a net, a packaging insert, packaging peanuts, a packet, a pad/layer sheet, paper, a peel-off lid, a plate/base, a pot, a pouch, a pump dispenser, a roll, a sleeve, a stick, a straw, a string, a tag, a tank, tape, a tea bag, a tie, a tray/punnet, a trigger spray, a tub, a tube, a utensil, a window, and a wrap.

Referring again to FIG. 1, the disposal parameter component 165 may query (step 7) the location storage 195 for disposal parameter data 150. For example, the disposal parameter component 165 may identify location information (e.g., GPS coordinates, or a geographic area identifier, such as a zip code, town/city/village name, or the like) in the request data 130, and query the location storage 195 for disposal parameter data 150 including the disposal scheme(s), disposal bin(s), material(s), and component(s) data associated with the location information in the location storage 195. For further example, if the disposal parameter component 165 identifies location information and preferred disposal scheme information (for the location) in the request data 130, the disposal parameter component 165 may query the location storage 195 for disposal parameter data 150 including the disposal bin(s), material(s), and component(s) data associated with the location and preferred disposal scheme information in the location storage 195. This latter example may result in decreased compute power and/or time as compared to if the disposal parameter component 165 queries the location storage 195 using only location information represented in the request data 130. The disposal parameter component 165 may send (step 8) the disposal parameter data 150 to the recommendation component 175.

In some embodiments, the product identification component 155 may process at least partially in parallel to the disposal parameter component 165. In some embodiments, at least two of steps 5-7 may be performed at least partially in parallel.

The recommendation component 175 is configured to process the product data 140 and the disposal parameter data 150 to generate recommendation data 160. The recommendation component 175 may be configured to generate the recommendation data 160 to include disposal guidance for each disposal scheme represented in the disposal parameter data 150 (e.g., first guidance for a first disposal scheme, second guidance for a second disposal scheme, and so on). For each disposal scheme, the recommendation component 175 may generate disposal bin/material-, disposal bin/component-, or disposal bin/component/material-level guidance, for the material(s) and/or component(s) represented in the product data 140, based on the material and/or component information in the disposal parameter data 150. In some situations, the location storage 195 may store an alternative disposal option (i.e., alternative to configured disposal schemes) for the location of the computing device 105.

For example, an alternative disposal option may be that a product's components can be disposed of by the user taking the product's components to a transfer station corresponding to the location of the computing device 105. For further example, an alternative disposal option may require the user to bring the product (e.g., bottle, plastic bag, etc.) to a certain location (e.g., bottle return center, supermarket, etc.). In such instances, the recommendation component 175 may generate alternative disposal option/material-, alternative disposal option/component-, or alternative disposal option/component/material-level guidance, for the material(s) and/or component(s) represented in the product data 140, based on the material and/or component information in the disposal parameter data 150.

In some embodiments, the product storage 185 and the location storage 195 may be implemented as structured query language (SQL) databases, and the recommendation component 175 may use JavaScript that interfaces with the SQL databases to generate the recommendation data 160. In some embodiments, JavaScript may be used for Hypertext Transfer Protocol (HTTP)/Hypertext Transfer Protocol Secure (HTTPS) server processes, and the connection may remain open while the computing system 115 processes as described herein.

In some embodiments, the recommendation component 175 may apply one or more weights (or priorities) when generating the recommendation data 160. For example, when a component is capable of being disposed of in two or more manners (e.g., if the component is acceptable by two or more disposal bins of a disposal scheme, or if the component is capable of being disposed of using (i) a disposal bin of a disposal scheme or (ii) an alternative disposal option associated with the computing device's location), the recommendation component 175 may apply one or more weights (or priorities) to generate the recommendation data 160 to account for the benefits of the different disposal options.

The computing system 115 may send (step 9) the recommendation data 160 to the computing device 105, where the recommendation data 160 may be sent to the application 145. The application 145 may cause the computing device 105 to display the guidance represented in the recommendation data 160. In instances where the recommendation data 160 is specific to a single disposal scheme, the application 145 may cause the computing device 105 to display the disposal bin/material-, disposal bin/component-, or disposal bin/component/material-level guidance represented in the recommendation data 160. In instances where the recommendation data 160 includes guidance for two or more disposal schemes, the application 145 may cause the computing device 105 to display a drop-down list, plurality of virtual toggles/buttons, or some other selectable feature that enables the user to select one of the disposal schemes represented in the recommendation data 160. In instances where the recommendation data 160 is specific to an alternative disposal option, the application 145 may cause the computing device 105 to display the alternative disposal option/material-, alternative disposal option/component-, or alternative disposal option/component/material-level guidance represented in the recommendation data 160. Upon the user selecting a disposal scheme or an alternative disposal option, the application 145 causes the computing device 105 to display the disposal bin/material-, disposal bin/component-, disposal bin/component/material-, alternative disposal option/material-, alternative disposal option/component-, or alternative disposal option/component/material-level guidance for the selected disposal scheme or alternative display option.

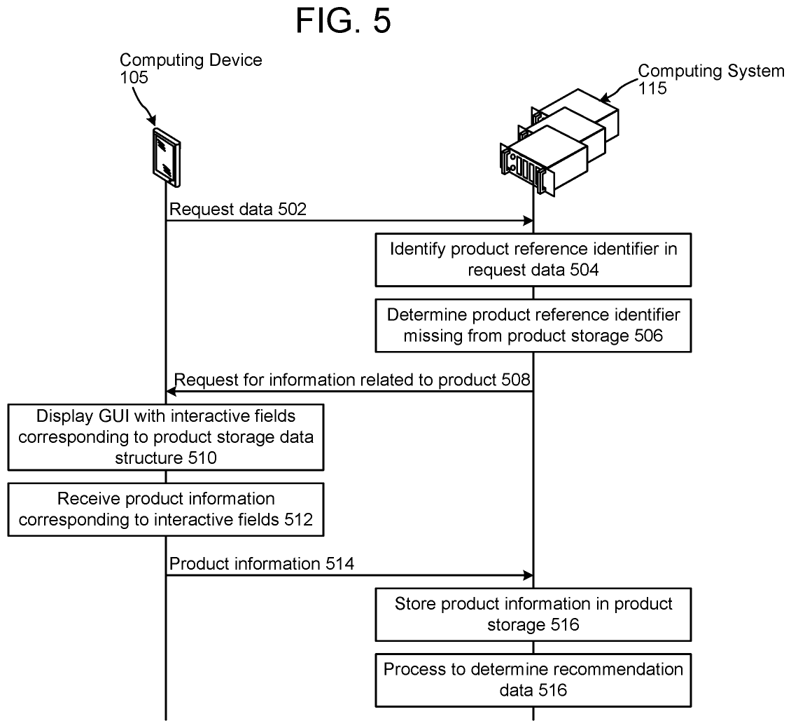

In some instances, the computing system 115 may not store data for a product to be disposed of, and thus may be unable to provide recommendation data based solely on receiving the request data 130. FIG. 5 illustrates the processing that may be performed in such situations.

Referring to FIG. 5, the computing device 105 may generate request data (as described herein above with respect to FIG. 1). The computing device 105 may send (step 502) the request data to the computing system 115. The request data may include data corresponding to at least a product reference identifier (e.g., barcode or QR code) corresponding to a product for which disposal guidance is requested.

The computing system 115 may identify (step 504) the product reference identifier in the request data, and may determine (step 506) that the product reference identifier is missing from the product storage 185. For example, the product identification component 155 may query the product storage 185 using the product reference identifier, and may receive a response from the product storage 185 including a null value. In response to determining the product reference identifier is missing from the product storage 185, the computing system 115 may send (step 508), to the computing device 105, a request for information related to the product for which disposal guidance is requested.

The computing device 105 (and more particularly the application 145) may store a template for obtaining information corresponding to a product and which may conform to the data structure in the product storage 185. For example, the template may include a field to be populated with a product reference identifier, a field to be populated with a container type, an expandable field to be populated with one or more components, an expandable field to be populated with one or more materials corresponding to the one or more components, an expandable field to be populated with one or more packaging symbols, an expandable field to be populated with one or more contents, an expandable field to be populated with one or more product categories, and an expandable field to be populated with one or more product types. The computing device 105 may display (step 510) (and more particularly the application 145 may cause the computing device 105 to display) a GUI within interactive fields corresponding to the data structure of the product storage 185 (in other words corresponding to the foregoing fields of the template). For example, the user may use the camera(s) 125 of the computing device 105 to capture an image of the product reference identifier in order to populate the product reference identifier portion of the GUI, or the user may type the reference product identifier into the product reference identifier portion of the GUI; the user may select a container type from a drop-down list of the GUI; the user may select a component(s) from a drop-down list(s) of the GUI; the user may select a material(s) from a drop-down list(s) of the GUI; the user may select a packaging symbol(s) from a drop-down list(s) of the GUI; the user may select a content(s) from a drop-down list(s) of the GUI; the user may select one or more product categories from a drop-down list(s) of the GUI; and/or the user may select a product type(s) from a drop-down list(s) of the GUI. For example, once the user selects a container type, the computing device 105 may prompt the user to select one or more components from a list of components pre-stored by the computing device 105 to be associated with the container type, one or more packaging symbols from a list of packaging symbols pre-stored by the computing device 105 to be associated with the container type, one or more contents from a list of contents pre-stored by the computing device 105 to be associated with the container type, one or more product categories from a list of product categories pre-stored by the computing device 105 to be associated with the content(s), and/or one or more product types from a list of product types pre-stored by the computing device 105 to be associated with the content(s). For further example, once the user selects a component, the computing device 105 may prompt the user to select a material from a list of materials pre-stored by the computing device 105 to be associated with the component. The user may not be required to populate all of the foregoing fields of the template. Upon receiving (step 512) the request information, the computing device 105 may send (step 514) the requested information to the computing system 115.

The computing system 115 thereafter store (step 516) the requested product information in the product storage 185, and may process (step 518) to determine recommendation data 160. That is, once the product information is stored in the product storage 185, the computing system 115 may cause the product identification component 155, the disposal parameter component 165, and the recommendation component 175 to process (as described herein above with respect to FIG. 1) to generate recommendation data 160. While not illustrated in FIG. 5, the computing system 115 may send this recommendation data to the computing device 105, and the computing device 105 may thereafter process as described herein above with respect to FIG. 1.

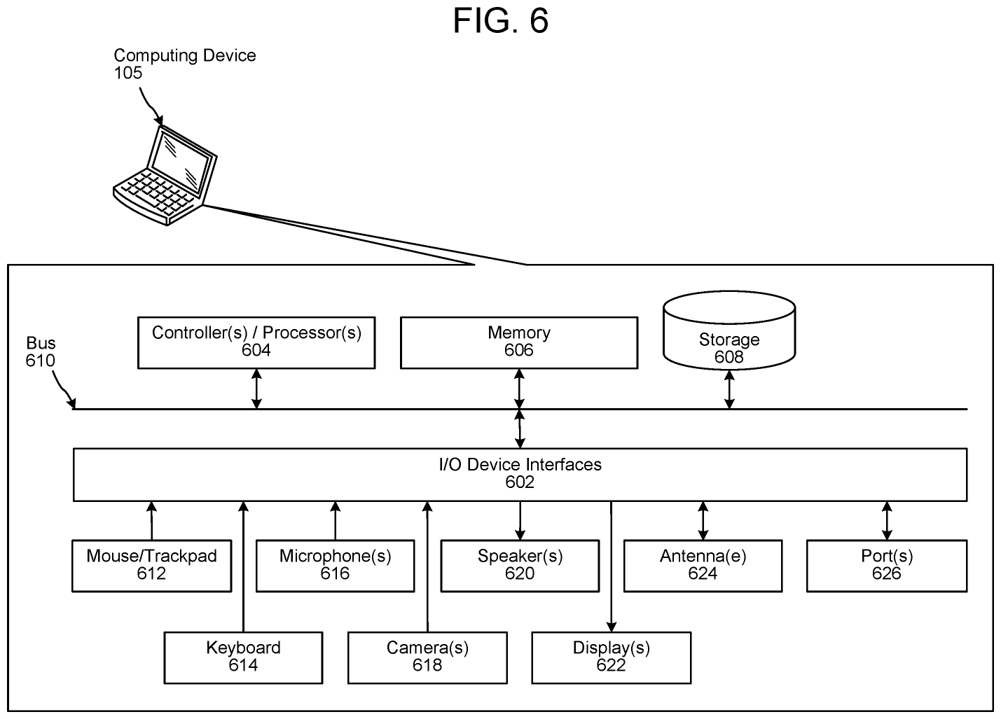

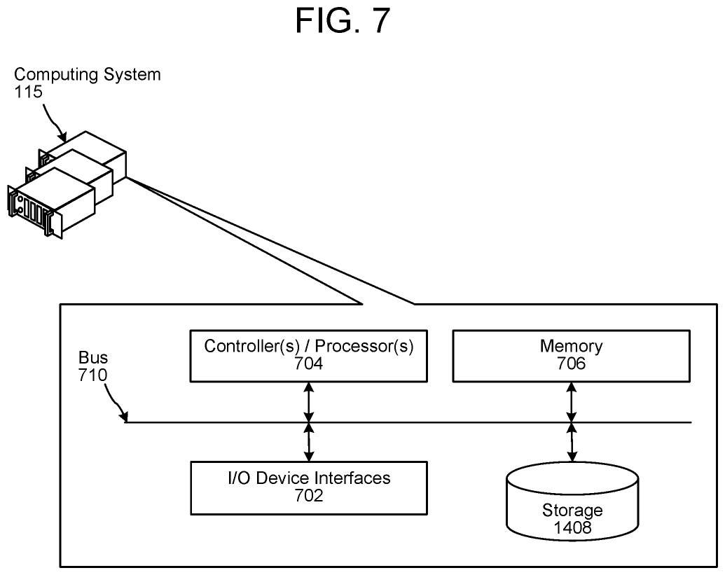

FIG. 6 is a block diagram conceptually illustrating example components of the computing device 105. FIG. 7 is a block diagram conceptually illustrating example components of the computing system 115. The computing system 115 may include one or more servers. A “server” as used herein may refer to a traditional server as understood in a server/client computing structure but may also refer to a number of different computing components that may assist with the operations discussed herein. For example, a server may include one or more physical computing components (such as a rack server) that are connected to other devices/components either physically and/or over a network and is capable of performing computing operations. A server may also include one or more virtual machines that emulates a computer system and is run on one or across multiple devices. A server may also include other combinations of hardware, software, firmware, or the like to perform operations discussed herein. The computing system 115 may be configured to operate using one or more of a client-server model, a computer bureau model, grid computing techniques, fog computing techniques, mainframe techniques, utility computing techniques, a peer-to-peer model, sandbox techniques, or other computing techniques.

Each of the computing device 105 and the computing system 115 may include one or more controllers/processors (604/704), which may each include a central processing unit (CPU) for processing data and computer-readable instructions, and a memory (606/706) for storing data and instructions. The memories (606/706) may individually include volatile random access memory (RAM), non-volatile read only memory (ROM), non-volatile magnetoresistive memory (MRAM), and/or other types of memory. Each of the computing device 105 and the computing system 115 may also include a data storage component (608/708) for storing data and controller/processor-executable instructions. Each data storage component (608/708) may individually include one or more non-volatile storage types such as magnetic storage, optical storage, solid-state storage, etc. Each of the computing device 105 and the computing system 115 may also be connected to removable or external non-volatile memory and/or storage (such as a removable memory card, memory key drive, networked storage, etc.) through respective input/output device interfaces (602/702).

Computer instructions for operating each of the computing device 105 and the computing system 115 and its various components may be executed by the respective device's controller(s)/processor(s) (604/704), using the memory (606/706) as temporary “working” storage at runtime. A device's computer instructions may be stored in a non-transitory manner in non-volatile memory (606/706), storage (608/708), or an external device(s). Alternatively, some or all of the executable instructions may be embedded in hardware or firmware on the respective device in addition to or instead of software.

Each of the computing device 105 and the computing system 115 includes input/output device interfaces (602/702). A variety of components may be connected through the input/output device interfaces (602/702), as will be discussed further below. Additionally, each of the computing device 105 and the computing system 115 may include an address/data bus (610/710) for conveying data among components of the respective device. Each component within the computing device 105 or the computing system 115 may also be directly connected to other components in addition to (or instead of) being connected to other components across the bus (610/710).

Referring to FIG. 6, the computing device 105 may include input/output device interfaces 602 that connect to a variety of components such as, but not limited to, a mouse and/or trackpad 612, a keyboard 614, one or more microphones 616, one or more cameras 618, one or more speakers 620, one or more displays 622, one or more antennae 624 (for connecting to one or more networks), and one or more ports 1326 for connecting the computing device 105 to an external device via a wire.

Via the one or more antennae XXV14, the input/output device interfaces 602 may connect to one or more networks via a wireless local area network (WLAN) (such as Wi-Fi) radio, Bluetooth, and/or wireless network radio, such as a radio capable of communication with a wireless communication network such as a Long Term Evolution (LTE) network, WiMAX network, 3G network, 4G network, 5G network, etc. A wired connection such as Ethernet may also be supported. The input/output device interfaces (602/702) may also include communication components that allow data to be exchanged between devices, such as different physical servers in a collection of servers or other components.

The components of the computing device 105 and/or the computing system 115 may include their own dedicated processors, memory, and/or storage. Alternatively, one or more of the components of the computing device 105 and/or the computing system 115 may utilize the input/output interfaces (602/702), processor(s) (604/704), memory (606/706), and/or storage (608/708) of the computing device 105 or the computing system 115, respectively.

The concepts disclosed herein may be applied within a number of different devices and computer systems, including, for example, general-purpose computing systems, speech processing systems, and distributed computing environments.

The above aspects of the present disclosure are meant to be illustrative. They were chosen to explain the principles and application of the disclosure and are not intended to be exhaustive or to limit the disclosure. Many modifications and variations of the disclosed aspects may be apparent to those of skill in the art. Persons having ordinary skill in the art should recognize that components and process steps described herein may be interchangeable with other components or steps, or combinations of components or steps, and still achieve the benefits and advantages of the present disclosure. Moreover, it should be apparent, to one skilled in the art, that the disclosure may be practiced without some or all of the specific details and steps disclosed herein.

Aspects of the disclosure may be implemented as a computer-implemented method or as an article of manufacture such as a memory device or non-transitory computer readable storage medium. The computer readable storage medium may be readable by a computer and may comprise instructions for causing a computer to perform processes described in the present disclosure. The computer readable storage medium may be implemented by a volatile computer memory, non-volatile computer memory, hard drive, solid-state memory, flash drive, removable disk, and/or other media. In addition, components of system may be implemented in firmware or hardware.

Conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements, and/or steps are in any way required for one or more embodiments. The terms “comprising,” “including,” “having,” and the like are synonymous and are used inclusively, in an open-ended fashion, and do not exclude additional elements, features, acts, operations, and so forth.

Disjunctive language such as the phrase “at least one of X, Y, Z,” unless specifically stated otherwise, is understood with the context as used in general to present that an item, term, etc., may be either X, Y, or Z, or any combination thereof, e.g., X, Y, and/or Z. Thus, such disjunctive language is not generally intended to, and should not, imply that certain embodiments require at least one of X, at least one of Y, or at least one of Z to each be present.

As used in this disclosure, the term “a” or “one” may include one or more items unless specifically stated otherwise. Further, the phrase “based on” is intended to mean “based at least in part on” unless specifically stated otherwise.

What is claimed is:

1. A computing system for generating component-level disposal guidance for a product, the computing system comprising:
at least one processor; and
at least one memory comprising instructions that, when executed by the at least one processor, cause the computing system to:
receive, from a computing device, a first request for disposal information for a first product, the first request comprising:
a reference identifier of the first product, and
location information;
determine, in a first storage, product information associated with the reference identifier of the first product, the product information including one or more of:
one or more components of the first product,
one or more packaging symbols of the first product, and
one or more contents of the first product;
determine, in a second storage, a disposal scheme associated with the location information;
determine, in the second storage, disposal bin information associated with the disposal scheme, the disposal bin information representing one or more types of disposal bins, wherein each of the one or more types of disposal bins is represented as being usable to dispose of one or more corresponding types of material;
using the disposal bin information and the product information, determine disposal data for the first product, wherein the disposal data provides disposal guidance at a disposal bin/product component level; and
send the disposal data to the computing device for output.

2. The computing system of claim 1, wherein the reference identifier is a barcode or a quick response (QR) code.

3. The computing system of claim 1, wherein the first request further comprises an image of the reference identifier, and wherein the at least one memory further comprises instructions that, when executed by the at least one processor, further cause the computing system to:
process the image to identify the reference identifier.

4. The computing system of claim 1, wherein the location information comprises latitude and longitude coordinates of the computing device.

5. The computing system of claim 1, wherein the location information comprises a geographic area identifier.

6. The computing system of claim 1, wherein the first request further comprises information for a disposal program to be used to dispose of the first product.

7. The computing system of claim 1, wherein the one or more components comprise one or more of a 6 pack ring, an aerosol can, an applicator, a backing, a bag, a band, a binding, a blister pack, a book backing, a bottle, a box, a bubble wrap, a bucket, a can, a canister, a cap, a card, a carrier, a case, a clamshell, a coffee pod, a cork, a cup, a detachable nozzle, an egg carton, an envelope, a film, a flat-top carton, a foil, a gable-top carton, glitter, a handle, a hanger, a jar, a jug, a label, a lid, a net, a packaging insert, packaging peanuts, a packet, a pad/layer sheet, paper, a peel-off lid, a plate/base, a pot, a pouch, a pump dispenser, a roll, a sleeve, a stick, a straw, a string, a tag, a tank, tape, a tea bag, a tie, a tray/punnet, a trigger spray, a tub, a tube, a utensil, a window, and a wrap.

8. The computing system of claim 1, wherein the one or more packaging symbols comprise one or more of B-Corps, 1% for the Planet, Friend of the Sea, Friend of the Earth, Fairtrade, Ecocert, PETA Bunny, Leaping Bunny, RSPO, FSC, Dolphin Safe, BPI, Global Organic Textile Standard, Global Recycle Standard, The Green Dot, Green Globe Certification, MSC, Non-GMO, Rainforest Alliance, World Land Trust, TerraCycle, Loop, Fair For Life, Certified Humane, Refill, Safer Choice, and Energy Star, FSC: Mix From Responsible Sources, Elopak, Tetra Pak, Magnetic Tin, Recyclable Aluminium, Aluminium 41, Metal Recycles Forever, Steel 40, FSC: Made From Recycled Material, FSC: Made From Well-Managed Forests, PEFC, Corrugated Recycles, RESY, Cardboard 20, Mixed Paper 21, Paper 22, Paperboard 23, Paper and Plastic 81, 100% Recycled Paperboard, PET, R-PET, HDPE, PVC, LDPE, PP, PS, ABS, Polyamide, FEVE, Clear Glass 70, Green Glass 71, Brown Glass 72, Seedling, Home Composting, OK Compost, OK Biodegradable, Wood 50, Cork 51, Cotton 60, WEEE, Gluten-Free, and Mobius Loop.

9. The computing system of claim 1, wherein the disposal scheme is selected from the group consisting of a public disposal scheme and a private disposal scheme.

10. The computing system of claim 1, wherein the at least one memory further comprises instructions that, when executed by the at least one processor, further cause the computing system to:
receive, from a computing device, a second request for disposal information for a second product, the second request comprising a reference identifier of the second product;
determine the reference identifier, of the second product, is missing from the first storage;
send, to the computing device, first data requesting information related to the second product;
receive, from the computing device, second data representing one or more of:
one or more components of the second product,
one or more packaging symbols of the second product, and
one or more contents of the product; and
store, in the first storage, an association between the reference identifier, of the second product, and the second data.

11. The computing system of claim 1, wherein the first request indicates a preconfigured disposal scheme, and wherein the at least one memory further comprises instructions that, when executed by the at least one processor, further cause the computing system to:
determine, in the second storage, the disposal scheme to be the preconfigured disposal scheme.

12. The computing system of claim 1, wherein the at least one memory further comprises instructions that, when executed by the at least one processor, further cause the computing system to:
determine an alternative disposal option associated with the location information; and
using the alternative disposal option and the product information, determine the disposal data to further provide disposal guidance at an alternative disposal option/product component level.

13. The computing system of claim 1, wherein the product information further includes a product category.

14. The computing system of claim 1, wherein the product information further includes a product type.

15. A computer-implemented method for generating component-level disposal guidance for a product, the computer-implemented method comprising the steps of:
receiving, from a computing device, a first request for disposal information for a first product, the first request comprising:
a reference identifier of the first product, and
location information;
determining, in a first storage, product information associated with the reference identifier of the first product, the product information including one or more of:
one or more components of the first product,
one or more packaging symbols of the first product, and
one or more contents of the first product;
determining, in a second storage, a disposal scheme associated with the location information;
determining, in the second storage, disposal bin information associated with the disposal scheme, the disposal bin information representing one or more types of disposal bins, wherein each of the one or more types of disposal bins is represented as being usable to dispose of one or more corresponding types of material;
using the disposal bin information and the product information, determining disposal data for the first product, wherein the disposal data provides disposal guidance at a disposal bin/product component level; and
sending the disposal data to the computing device for output.

16. The computer-implemented method of claim 15, wherein the reference identifier is a barcode or a quick response (QR) code.

17. The computer-implemented method of claim 15, wherein the first request further comprises an image of the reference identifier, and wherein the computer-implemented method further comprises processing the image to identify the reference identifier.

18. The computer-implemented method of claim 15, wherein the location information comprises latitude and longitude coordinates of the computing device.

19. The computer-implemented method of claim 15, wherein the location information comprises a geographic area identifier.

20. The computer-implemented method of claim 15, wherein the first request further comprises information for a disposal program to be used to dispose of the first product.

21. The computer-implemented method of claim 15, wherein the one or more components comprise one or more of a 6 pack ring, an aerosol can, an applicator, a backing, a bag, a band, a binding, a blister pack, a book backing, a bottle, a box, a bubble wrap, a bucket, a can, a canister, a cap, a card, a carrier, a case, a clamshell, a coffee pod, a cork, a cup, a detachable nozzle, an egg carton, an envelope, a film, a flat-top carton, a foil, a gable-top carton, glitter, a handle, a hanger, a jar, a jug, a label, a lid, a net, a packaging insert, packaging peanuts, a packet, a pad/layer sheet, paper, a peel-off lid, a plate/base, a pot, a pouch, a pump dispenser, a roll, a sleeve, a stick, a straw, a string, a tag, a tank, tape, a tea bag, a tie, a tray/punnet, a trigger spray, a tub, a tube, a utensil, a window, and a wrap.

22. The computer-implemented method of claim 15, wherein the one or more packaging symbols comprise one or more of B-Corps, 1% for the Planet, Friend of the Sea, Friend of the Earth, Fairtrade, Ecocert, PETA Bunny, Leaping Bunny, RSPO, FSC, Dolphin Safe, BPI, Global Organic Textile Standard, Global Recycle Standard, The Green Dot, Green Globe Certification, MSC, Non-GMO, Rainforest Alliance, World Land Trust, TerraCycle, Loop, Fair For Life, Certified Humane, Refill, Safer Choice, and Energy Star, FSC: Mix From Responsible Sources, Elopak, Tetra Pak, Magnetic Tin, Recyclable Aluminium, Aluminium 41, Metal Recycles Forever, Steel 40, FSC: Made From Recycled Material, FSC: Made From Well-Managed Forests, PEFC, Corrugated Recycles, RESY, Cardboard 20, Mixed Paper 21, Paper 22, Paperboard 23, Paper and Plastic 81, 100% Recycled Paperboard, PET, R-PET, HDPE, PVC, LDPE, PP, PS, ABS, Polyamide, FEVE, Clear Glass 70, Green Glass 71, Brown Glass 72, Seedling, Home Composting, OK Compost, OK Biodegradable, Wood 50, Cork 51, Cotton 60, WEEE, Gluten-Free, and Mobius Loop.

23. The computer-implemented method of claim 15, wherein the disposal scheme is selected from the group consisting of a public disposal scheme and a private disposal scheme.

24. The computer-implemented method of claim 15, further comprising:
receiving, from a computing device, a second request for disposal information for a second product, the second request comprising a reference identifier of the second product;
determining the reference identifier, of the second product, is missing from the first storage;
sending, to the computing device, first data requesting information related to the second product;
receiving, from the computing device, second data representing one or more of:
one or more components of the second product,
one or more packaging symbols of the second product, and
one or more contents of the product; and
storing, in the first storage, an association between the reference identifier, of the second product, and the second data.

25. The computer-implemented method of claim 15, wherein the first request indicates a preconfigured disposal scheme, and wherein the computer-implemented method further comprises determining, in the second storage, the disposal scheme to be the preconfigured disposal scheme.

26. The computer-implemented method of claim 15, further comprising:
determine an alternative disposal option associated with the location information; and using the alternative disposal option and the product information, determine the disposal data to further provide disposal guidance at an alternative disposal option/product component level.

27. The computer-implemented method of claim 15, wherein the product information further includes a product category.

28. The computer-implemented method of claim 15, wherein the product information further includes a product type.
